(19) United States
(12) Patent Application Publication
(10) Pub. No.: US 2019/0393707 A1
(43) Pub. Date: Dec. 26, 2019

(54) METHODS, APPARATUS, AND SYSTEMS TO FACILITATE CONTROL FOR A LOW-POWER BATTERY STATE

(71) Applicant: Texas Instruments Incorporated, Dallas, TX (US)

(72) Inventors: Bradford Lawrence Hunter, Spicewood, TX (US); Terry Lee Sculley, Lewisville, TX (US)

(21) Appl. No.: 16/014,842

(22) Filed: Jun. 21, 2018

(51) Int. Cl. H02J 7/00; H02J 7/02

(52) U.S. Cl. CPC H02J 7/0063; H02J 2007/0067; H02J 7/025; H02J 7/0016

(57) ABSTRACT

Methods, systems, and apparatus to facilitate control for a low-power battery state are disclosed. An example apparatus includes a charge pump coupled to a power terminal and a charge pump switch, the charge pump switch coupled to a discharging terminal; a power supply switch circuit coupled to the power terminal and the discharging terminal, the power supply switch circuit being connected to bypass the charge pump and the charge pump switch; and a switch controller coupled to the charge pump switch and the power supply switch circuit.

### FIELD OF THE DISCLOSURE

This disclosure relates generally to battery control and, more particularly, to methods, apparatus, and systems to facilitate control for a low-power battery state.

### BACKGROUND

Battery packs, such as lithium ion battery packs, include a battery and circuitry to charge and/or discharge the battery to/from a load. Some battery packs include one or more transistors to enable the control the charging and/or discharging of the battery. In some examples, the voltage required to control the one or more transistors is above the voltage supplied by the battery. In such examples, a charge pump may be used to turn on (e.g., enable) and keep on the one or more transistors to be able to provide power to a load and/or receive power from a load.

### SUMMARY

Certain examples disclosed herein facilitate control for a low-power battery state. An example apparatus includes a charge pump coupled to a power terminal and a charge pump switch, the charge pump switch coupled to a discharging terminal. The example apparatus further includes a power supply switch circuit coupled to the power terminal and the discharging terminal, the power supply switch circuit being connected to bypass the charge pump and the charge pump switch. The example apparatus further includes a switch controller coupled to the charge pump switch and the power supply switch circuit.

Certain examples disclosed herein facilitate control for a low-power battery state. An example apparatus includes a power supply switch circuit to, when enabled, provide a first voltage to a discharging terminal. The example apparatus further includes a charge pump to, when enabled, provide a second voltage higher than the first voltage to the discharging terminal. The example apparatus further includes a controller to enable the power supply switch circuit or the charge pump based on at least one of instructions from a host controller or a current being drawn from a power supply corresponding to the first voltage.

Certain examples disclosed herein facilitate control for a low-power battery state. An example system includes a power supply. The example system further includes a field effect transistor including a drain connected to the power supply and a source connected to a positive terminal. The example system further includes an integrated circuit to when a host device is operating in a low power mode, couple the power supply to a gate of the field effect transistor; and when the host device is operating in a high power mode, couple a charge pump to the gate of the field effect transistor, the charge pump providing a voltage higher than a power supply voltage of the power supply.

### BRIEF DESCRIPTION OF THE DRAWINGS

FIG. 1 illustrates an example power supply pack including an example power supply and an example power supply controller to facilitate control for a low-power state.

FIG. 2 illustrates an example field effect transistor-based switching circuit of FIG. 1.

FIG. 3 illustrates an alternative example field effect transistor-based switching circuit of FIG. 1.

FIG. 4 illustrates an alternative example power supply pack including an example power supply and an example power supply controller to facilitate control for a lower power state.

FIG. 5 is a block diagram of an example switch controller of FIG. 1.

FIG. 6 is a flowchart representative of example machine readable instructions that may be executed to implement the example switch controller of FIGS. 1, 4, and 5.

FIG. 7 illustrates an example timing diagram corresponding to node voltages of FIGS. 1 and/or 4.

FIG. 8 is an example processor platform that may execute the example computer readable instructions of FIG. 6 to implement the example switch controller of FIGS. 1, 4, and 5.

The figures are not to scale. Wherever possible, the same reference numbers will be used throughout the drawing(s) and accompanying written description to refer to the same or like parts.

### DETAILED DESCRIPTION

Portable products rely on power supplies (e.g., batteries) to provide power for operation. For example, a portable device may utilize a lithium ion battery in a battery pack to provide power to the portable device. Some battery packs include series field effect transistor (FET) protection in line with the positive terminal of the battery. Such battery packs include a protector integrated circuit (IC) to control the series FETs for the charging and discharging of the battery(ies). For example, the protector IC may (A) enable a first FET of the series FETs to allow a high voltage from the connected portable device (e.g., a host device) to charge the battery and (B) enable a second FET of the series FETs to allow the battery to discharge, thereby providing power to the connected portable device.

Because a load of a host device may draw a lot of current from a battery, one or more charge pumps may be required to increase the battery voltage to enable the first FET or the second FET of the series FETs in a battery pack. The increased voltage is applied to the gate of the first or second FET to turn on the corresponding FET and keep it on. Such charge pumps consume substantial current (e.g., 50 microamps per pump). Accordingly, utilizing the charge pump to discharge the battery depletes the battery rather quickly. For high current/high-power modes (e.g., where the load of the portable device is high), a charge pump is necessary to adequately turn on the FET.

Some portable devices do not always operate in high-power modes. For example, if the portable device is a power tool, the power tool may operate in high-power mode/high-current mode and low-power/low-current mode during different time periods. In such an example, when the power tool is utilized, the power tool may draw a large amount of current from a battery (e.g., high-power mode); however, when the power tool is being stored, the power tool may have a microcontroller to perform small tasks and/or checks. Additionally or alternatively, a user may interact with a user interface of the power tool to check data related to the power tool. Operations of the interface and/or microcontroller may draw very small amounts of current (e.g., corresponding to low power mode) from the battery. For low current/power mode (e.g., where the load of the portable device is low), the voltage at the gate of the discharging FET does not need to be as high as it does in high-power modes. Accordingly, utilizing a charge pump to enable the battery to charge the power tool in low-power mode is a waste of resources, thereby corresponding to faster battery depletion.

Examples disclosed herein provide operation of a discharging FET in a battery pack in two modes (e.g., a low-power mode and a high-power mode). The high-power mode utilizes the charge pump to provide sufficient voltage to enable the discharging FET in high power modes. The low-power mode enables discharging through the FET without the use of the charge pump (e.g., by bypassing the charge pump). Rather, the low-power mode utilizes the voltage of the battery to enable the discharging FET. In this manner, due to not utilizing the charge pumps, the amount of power wasted to provide power in low power modes is significantly reduced, thereby extending the life of the battery.

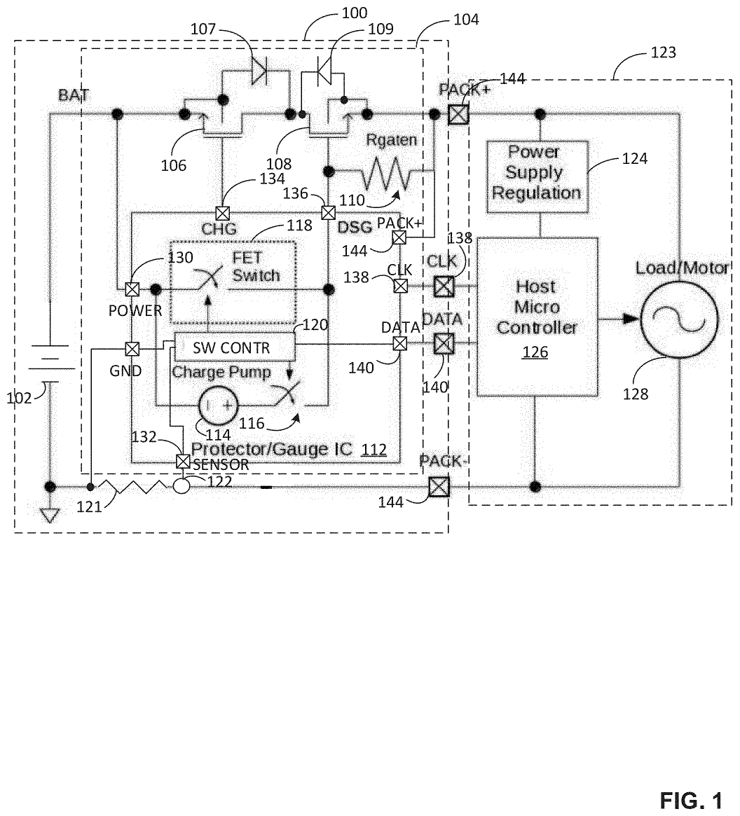

FIG. 1 illustrates an example power supply pack 100 including an example power supply 102 and an example power supply controller 104 to facilitate control for a lower power state during a discharging state. The power supply pack 100 of FIG. 1 includes the power supply 102, the power supply controller 104, example metal oxide semiconductor FETs (MOSFETs) 106, 108, example body diodes 107, 109, an example resistor 110, an example protector integrated circuit (IC) 112, an example charge pump circuit 114, an example switch 116, an example power supply switch circuit 118, an example switch controller 120, an example resistor 123, and an example sensor 122 (e.g., a current sensor or a voltage sensor, whose voltage corresponds to a current).

FIG. 1 further includes an example host device 123 coupled to the power supply pack 100 (e.g., via example positive and negative terminals (Pack+ and pack−)). The host device 123 includes an example power supply regulator 124, an example host microcontroller 126 and an example load 128 coupled to the power supply pack 100. FIG. 1 further includes an example power terminal (POWER) 130, an example sensor terminal (SENSOR) 132, an example charging terminal (CHG) 134, an example discharging terminal (DSG) 136, an example clock terminal (CLK) 138, an example data terminal (DATA) 140, an example PACK+ terminal 144, and an example PACK− terminal 144. The power supply 102 may be a battery (e.g., a lithium ion battery), an AC power supply, and/or any other type of power supply. The MOSFETs 106, 108 may be n-channel FETs, power FETs, and/or any other type of electronic switch. Additionally, in some examples, the power supply pack 100 may include a parallel power down path connecting the gate of the MOSFET 108 to the PACK+ terminal 144 for faster equalization (not shown).

The protector IC 112 receives data from the host controller 126 regarding whether to charge the power supply 102 or discharge the power supply 102 (e.g., thereby providing power to the load 128 in a low-power or high-power mode). As further described below, to charge the power supply 102, the protector IC 112 enables the MOSFET 106 and enables the MOSFET 108. In this manner, the current from the load can be used to charge the power supply 102 via the MOSFETs 106, 108. To discharge the power supply 102 in a low-power mode (e.g., when the current required for the load 128 is low), the protector IC 112 disables the MOSFET 106 and enables the MOSFET 108. In this manner, current flows from the power supply 102, through the body diode 107 of the MOSFET 106 and through the enabled MOSFET 108 to provide a small current to the load 128. To discharge the power supply 102 in high-power mode (e.g., when the current required for the load 126 is high), the protector IC 112 enables both MOSFETs 106, 108. In this manner, current flows through the enabled MOSFETs 106, 108 to provide a large current to the load 128.

The protector IC 112 of FIG. 1 controls the MOSFETs 106, 108 to charge the power supply 102 and/or to discharge the power supply 102 (e.g., to provide power to the power supply regulator 124 and the load 128 of the host device 123). In the example of FIG. 1, the MOSFETs 106, 108 are n-channel MOSFETs (e.g., nFETs). The protector IC 112 enables the example MOSFETS 106 using a high voltage applied to the CHG terminal 134 and using a low voltage applied to the DSG terminal 136. When the protector IC 112 applies a high voltage to the gate of the MOSFET 106 (e.g., a charging switch), the protector IC 112 enables (e.g., turns on) the MOSFET 106 to charge the power supply 102 using a high voltage (e.g., provided by the load 128) at the PACK+ terminal 144 (e.g., via current flowing through the body diode 109 of the MOSFET 108 and through the MOSFET 106). To discharge the power supply 102, the protector IC 112 applies a high voltage to the gate of the MOSFET 108 (e.g., a discharging switch) to enable the MOSFET 108. In this manner, the current from the power supply 102 flows through the body diode 107 of the MOSFET 106 (e.g., around the MOSFET 106) and through the MOSFET 108 to provide current to the power supply regulator 124 and the load 128. During high-power modes, the protector IC 112 may utilize the charge pump 114 provide a voltage to the gate of the MOSFET 108 that is enough to enable the MOSFET 108. The protector IC 112 may disable the MOSFET 108 by disabling the charge pump 114 and/or the power supply switch circuit 118, and the resistor 110 equalizes the gate voltage to turn off (e.g., disable) the MOSFET 108.

In low-power modes, the protector IC 112 of FIG. 1 may couple the gate of the MOSFET 108 directly to the power supply 102 via the power supply switch circuit 118 (e.g., bypassing the charge pump 114 and switch 116). In this manner, the system voltage is maintained by the body diode 107 of the MOSFET 106 and the enabled MOSFET 108, corresponding to a source follower configuration, which provides sufficient power for the host microcontroller 126 (e.g., via the power supply regulator 124), but not for the full load 128. In high-power mode, the system removes the source follower configuration by disabling the power supply switch circuit 118 and enabling the charge pump circuit 114 to provide a boost to the gate of the MOSFET 108 to provide sufficient current to power the load 128.

The protector IC 112 of FIG. 1 includes the charge pump 114, the charge pump switch 116, the power supply switch circuit 118 and the switch controller 120. The charge pump circuit 114 generates a voltage higher than the voltage of the power supply 102 to enable the MOSFET 108 for high power situations (e.g., where the load 128 draws a large current from the power supply 102). The charge pump circuit 114 is enabled when the charge pump switch 116 is closed. The charge pump circuit 114 requires a large current consumption, corresponding to a lot of power required to turn the MOSFET 108 on and keep it on (e.g., to supply sufficient current to create a voltage across the resistor 110 to enable the gate of the MOSFET 108). However, in a low power mode, the amount of voltage needed to provide the gate of the MOSFET 108 is much lower. Accordingly, in low power modes, the power supply switch circuit 118 may be utilized to drive the gate of the MOSFET 108 with less voltage than the charge pump 114. The protector IC 112 may include additional components not illustrated in FIG. 1. For example, the protector IC 112 may include an additional charge pump (not shown) coupled to the POWER terminal 130 and the charging (CHG) terminal 134 to enable the charging MOSFET 106.

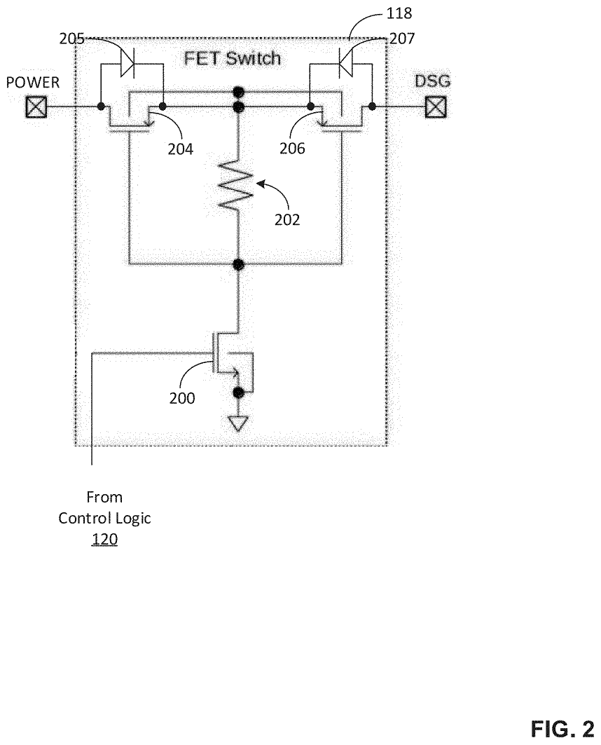

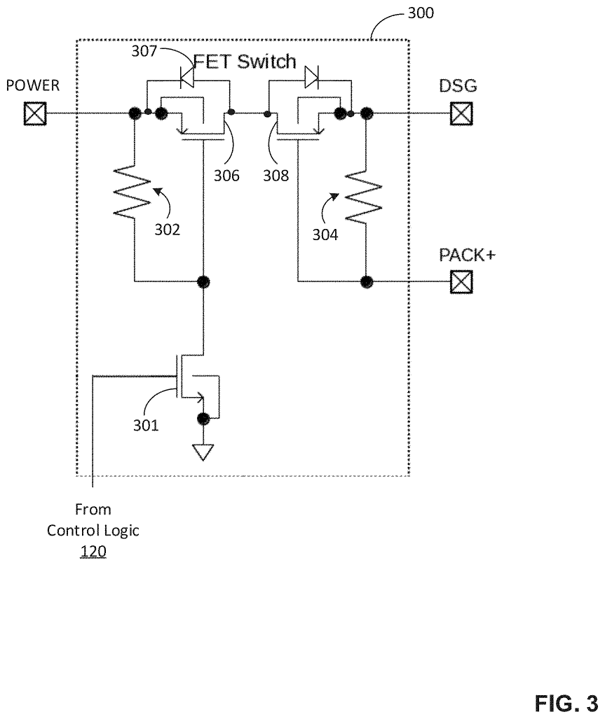

The power supply switch circuit 118 of FIG. 1, when enabled, bypasses the charge pump 114 provides the voltage of the power supply 102 to enable the gate of the MOSFET 108, thereby configuring the MOSFET 108 as a source follower. For example, when the power supply switch circuit 118 is enabled, the voltage at the power supply 102 is shorted to the gate of the MOSFET 108 and the charge pump 114 is bypassed (e.g., decoupled via the switch 116). Because the voltage at the drain of the MOSFET 108 is approximately one threshold voltage (e.g., corresponding to the body diode 109) below the battery voltage and the voltage at the source of the MOSFET 108 is approximately the battery voltage minus the threshold voltage minus the gate to source voltage of the MOSFET 108 (e.g., which is approximately the threshold voltage of the MOSFET 108), the battery voltage is sufficient to enable the gate of the MOSFET 108. In low-power modes, the voltage at the PACK+ terminal 144 is sufficient to provide the host microcontroller 126 (e.g., via the power supply regulator 124) with enough power to operate. Examples of the power supply switch circuit 118 is further described below in conjunction with FIGS. 2 and 3.

The switch controller 120 of FIG. 1 determines when to use the charge pump circuit 114 to control the discharging MOSFET 108 (e.g., for high current/high-power modes) and when to use the power supply switch circuit 118 to control the discharging MOSFET 108 (e.g., for low-current/low-power modes). The switch controller 120 may select a mode (e.g., high-power or low-power) based on a sensed current measurement or a voltage measurement corresponding to a sensed current measurement from the sensor 122 via the SENSOR terminal 132 and a ground terminal (e.g., corresponding to the voltage across the resistor 123) and/or based on instructions from the host microcontroller 126 (e.g., via the DATA terminal 140). For example, the resistor 121 is coupled to a node at the PACK+ terminal 144 and to ground (e.g., or Vss). In this manner, the switch controller 120 can determine the current by dividing the voltage across the resistor by the resistance of the resistor 121 and select a mode based on the sensed current. Additionally or alternatively, the microcontroller 126 may enter into low-power mode and disable the load 128. In such an example, the microcontroller 126 may inform the switch controller 120 that low-power mode has been initiated and the load 128 is disabled. Accordingly, the switch controller 120 may disable the charge pump 114 (e.g., by opening the switch 116) and enable the power supply switch circuit 118, thereby reducing power consumption. In this manner, the microcontroller 126 may still operate without the burden of the large amount of current drawn by the charge pump 114. When the microcontroller 126 is to enter in high-power mode (e.g., requiring high current), the microcontroller 126 may inform the switch controller 120. In this manner, the switch controller 120 may disable the power supply switch circuit 118 and enable the charge pump 114 (e.g., by closing the switch 116).

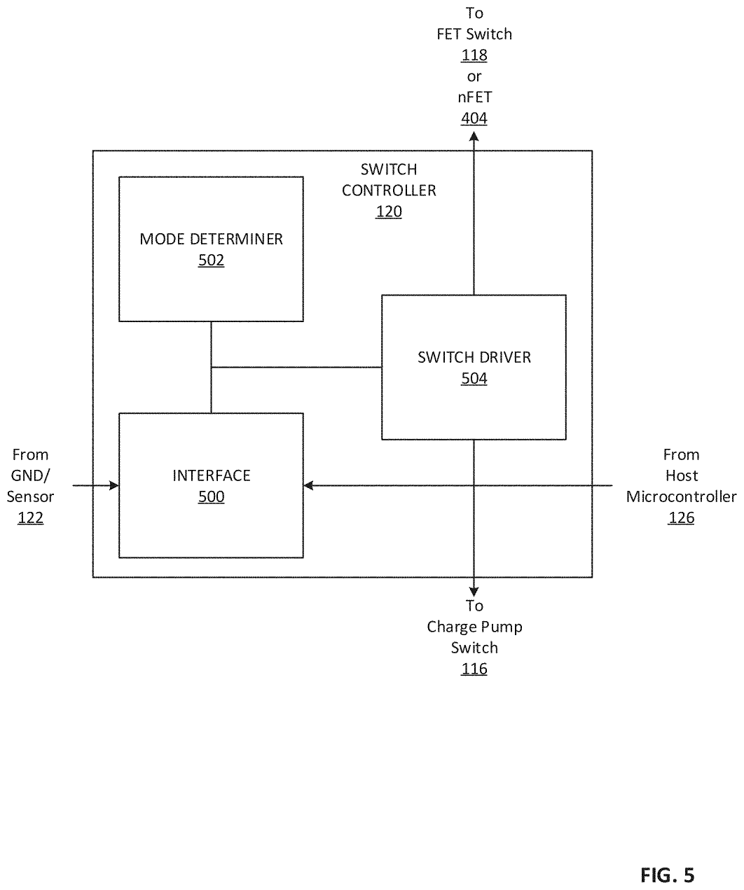

However, if the host microcontroller 126 of FIG. 1 faults and/or if there is no data connection between the host microcontroller 126 and the switch controller 120, the switch controller 120 may utilize current measurements from the sensor 122 to determine which mode to utilize. For example, if the sensor 122 measures a current (e.g., a voltage across the resistor 121 that is divided by the resistance of the resistor 121 to correspond to a current) above a maximum low current threshold, the switch controller 120 may adjust from power supply switch circuit control to charge pump control (e.g., to provide sufficient power without wearing out the components of the power supply controller 104). If the sensor 122 measures a current below the maximum low current threshold, the switch controller 120 may adjust from charge pump control to power supply switch circuit control (e.g., to conserve power). The switch controller 120 is further described below in conjunction with FIG. 5.

FIG. 2 is a circuit implementation of an example power supply switch circuit 118 that may be used for low-power battery states. The power supply switch circuit 118 includes an example MOSFET 200 (e.g., an n-channel FET (nFET)), an example resistor 202, and example MOSFETs 204, 206 (e.g., a p-channel FETS (pFETs)). The MOSFETs 200, 204, 206 may be power FETs and/or any other type of electronic switch.

The MOSFET 200 of FIG. 2 is a n-channel MOSFET that is controlled by a voltage applied by the switch controller 120 of FIG. 1. When the switch controller 120 applies a low voltage to the gate of the MOSFET 200, the MOSFET 200 disables (e.g., turns off). When the MOSFET 200 is off, the resistor 202 equalizes the gate of the MOSFETs 204, 206 to the body of the MOSFETs 204, 206, thereby disabling the MOSFETs 204, 206. Because each of the MOSFETs 204, 206 have example body diodes 205, 207 in opposite directions, when the MOSFETs 204 are disabled, current cannot flow from the battery (POWER) terminal 130 to the discharging (DSG) terminal 136 or vice versa, thereby disabling the MOSFET 108 of FIG. 1.

When the switch controller 120 applies a high voltage to the gate of the MOSFET 200 of FIG. 2, the MOSFET 200 enables (e.g., turns on). When the MOSFET 200 is on, the MOSFET 200 provides a path to ground, thereby allowing current to flow through the resistor 202 to provide a gate-to-source voltage (Vgs) drop across the MOSFETs 204, 206. Thus, the MOSFETs 204, 206 turn on and the POWER terminal 130 is shorted to the DSG terminal 136. In this manner, the voltage from the power supply 102 is provided to the gate of the MOSFET 108 of FIG. 1 to enable the MOSFET 108.

FIG. 3 is an alternative circuit implementation of an example power supply switch circuit 300 that may be used for low-power battery states. The alternative example power supply switch circuit 300 includes an example MOSFET 301 (E.g., an n-channel MOSFET), an example resistor 302, 304, and example MOSFETs 306, 308 (e.g., a p-channel MOSFET). The MOSFETs 301, 306, 308 may be power FETs and/or any other type of electronic switch.

The MOSFET 301 of FIG. 3 is a n-channel MOSFET controlled by a voltage applied by the switch controller 120 of FIG. 1. However, because the MOSFET 306 includes an example body diode 307, when the MOSFET 301 is disabled, current cannot flow from the DSG terminal 136 to the POWER terminal 130, whenever the voltage at PACK+ is above is above the voltage at BAT, regardless of the state (e.g., on or off) of the MOSFET 301.

When the switch controller 120 applies a high voltage to the gate of the MOSFET 301 of FIG. 3, the MOSFET 301 enables (e.g., turns on). When the MOSFET 301 is on, the MOSFET 301 provides a path to ground, thereby allowing current to flow through the resistor 302 to provide a Vgs drop across the MOSFET 306. The Vgs drop across the MOSFET 306 is sufficient to enable the MOSFET 306, thereby shorting the POWER terminal 130 to the source of the MOSFET 308. When the voltage at the PACK+ terminal 144 is less than the voltage at the DSG terminal 136, the voltage drop across the resistor 304 is sufficient to cause the MOSFET 308 to turn on (e.g., enable), thereby shorting the POWER terminal 130 to the DSG terminal 136 to cause the battery voltage to enable the MOSFET 108 of FIG. 1. Either of the power supply switch circuit 118 of FIG. 2 and the switch circuit 300 of FIG. 3 may be implemented in the protector IC 112 of FIG. 1, each corresponding to certain advantages and disadvantages. A user and/or manufacture may select one of the power supply switch circuits 118, 300 based on their preferences.

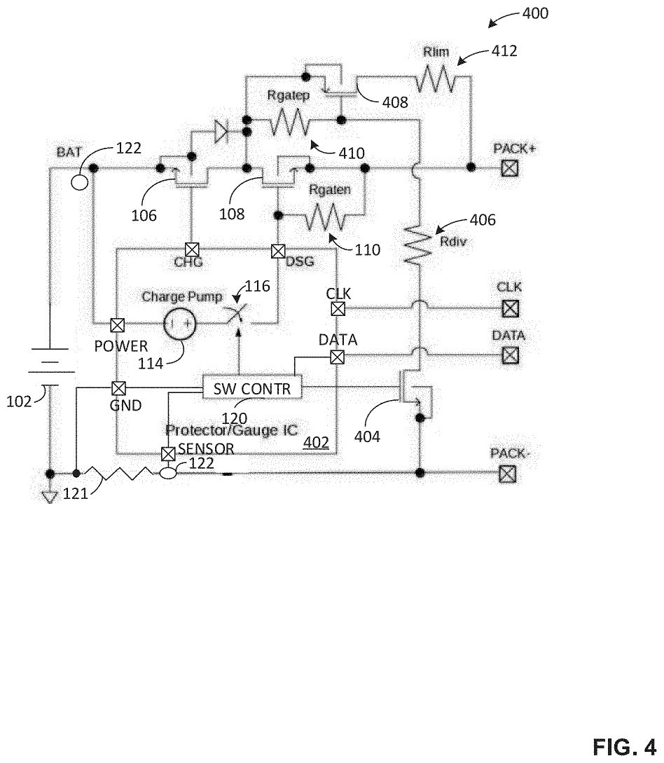

FIG. 4 illustrates an example battery pack 400 to facilitate control for a low-power battery state. The battery pack 400 of FIG. 4 includes the power supply 102, the MOSFETs 106, 108, the resistor 110, the charge pump circuit 114, the switch 116, the switch controller 120, and the sensor 122 of FIG. 1. The battery pack 400 further includes an alternative example protector IC 402, an example MOSFET 404 (e.g., an n-channel MOSFET), example resistors 406, 410, 412, and an example MOSFET 408 (e.g., a p-channel MOSFET). The alternative protector IC 402 may include additional components not illustrated in FIG. 4. For example, the protector IC 402 may include an additional charge pump (not shown) coupled to the POWER terminal 130 and the charging (CHG) terminal 134 to enable the charging MOSFET 106. The MOSFETs 404, 408, 410 may be power FETs and/or any other type of electronic switch.

The protector IC 402 of FIG. 4 includes the charge pump 114 the switch 116, and the switch controller 120 of FIG. 1. However, the protector IC 402 of FIG. 1 does not drive the gate of the MOSFET 108 using the power supply switch circuit 118 of FIG. 1. Instead, when the switch controller 120 determines that low-power mode should be initiated, the switch controller 120 outputs a high voltage to the MOSFET 404 (e.g., instead of the power supply switch circuit 118), thereby enabling the MOSFET 404. When the MOSFET 404 is enabled, current will be drawn from the power supply 102 through the resistor 410 and the resistor 406, thereby generating a Vgs voltage drop sufficient to turn on (e.g., enable) the MOSFET 408. The resistance of the resistors 406, 410 may be high to ensure that the current is low for the low-power mode. When the MOSFET 408 is enabled, current flows from the source to the drain of the MOSFET 408, which is limited by the resistor 412. Using the MOSFET 408, there is no need to generate a voltage that is higher than the voltage of the power supply 102. Accordingly, the voltage of the power supply 102 can be provided to the PACK+ terminal 144 without the use of the charge pump 114 for low-power mode by enabling the MOSFET 408 (e.g., when the switch controller 120 enabled the MOSFET 404). Although the example circuit of FIG. 4 may require additional components, the example circuit of FIG. 4 may be implemented on an existing protector IC 402 that does not support the power supply switch circuit 118 of FIG. 1.

FIG. 5 is a block diagram of the switch controller 120 of FIGS. 1 and 4. The switch controller 120 includes an example interface 500, an example mode determiner 502, and an example switch driver 504.

The interface 500 of FIG. 5 interfaces with the sensor 122 and/or the host microcontroller 126 (e.g., via the DATA terminal 140). In some examples, the interface 500 includes two interfaces (e.g., one for the sensor 122 and one for the host microcontroller 126). The sensor 122 provides current measurements (e.g., the amount of current being drawn from the power supply 102) to the interface 500. In some examples, the sensor 122 provides a voltage measurement and mode determiner 502 calculates the current by dividing the voltage measurement by the resistance of the resistor 121. The host microcontroller 126 provides instructions corresponding to a power mode (e.g., high-power or low-power). For example, if the host microcontroller 126 determines that the load 128 requires a large amount of current and/or is connected, the host microcontroller 126 may transmit instructions corresponding to the high-power mode to the interface 500. If the microcontroller 126 determines that the load 128 requires a small amount, or no, current and/or is disconnected, the host microcontroller 126 may transmit instructions corresponding to the low-power mode to the interface 500.

The mode determiner 502 of FIG. 5 makes a determination as to which mode to operate under (e.g., high-power mode or low-power mode) based on the received information from the sensor 122 and/or the host microcontroller 126. For example, if the host microcontroller 126 transmits instructions corresponding to a low-power mode, the mode determiner 502 selects the low-power mode. As described above, the low-power mode corresponds to disabling the charge pump 114 of FIGS. 1 and 4 and enabling the power supply switch circuit 118 of FIG. 1 or the MOSFET 404 of FIG. 4. If the host microcontroller 126 transmits instructions corresponding to a high-power mode, the mode determiner 502 selects the high-power mode. As described above, the high-power mode corresponds to enabling the charge pump 114 of FIGS. 1 and 4 and disabling the power supply switch circuit 118 of FIG. 1 or the MOSFET 404 of FIG. 4.

Additionally or alternatively, the mode determiner 502 of FIG. 5 may determine a mode and/or change modes based on a received current measurement from the sensor 122 (e.g., or a voltage corresponding to the current measurement). For example, the mode determiner 502 may compare the received current measurement to a maximum low current threshold. If the received current measurement is above the maximum low current threshold, the mode determiner 502 may utilize high-power mode and when the received current measurement is below the maximum low current threshold, the mode determiner 502 may utilize the low-power mode. In some example, the mode determiner 502 may override the mode corresponding to the instructions from the host microcontroller 126 based on the current measurement. For example, if the instructions from the host microcontroller 126 corresponds to a low-power mode and the current from the sensor 122 is above the maximum low current threshold, the mode determiner 502 may override the low-power instructions and select high-power mode to protect the components of the battery packs 100, 400.

The switch driver 504 of FIG. 5 drives the power supply switch circuit 118 of FIG. 1, the MOSFET 404 of FIG. 4, and/or the charge pump 114 of FIGS. 1 and 4 by applying one or more voltages based on the selected mode. For example, if the mode determiner 502 selects a low-power mode, the switch driver 504 applies a first voltage (e.g., a high voltage) to the power supply switch circuit 118 of FIG. 1 or the MOSFET 404 of FIG. 4 and applies a second voltage (e.g., the low voltage) to the charge pump switch 116. In this manner, the switch driver 504 enables low-power mode by enabling the power supply switch circuit 118 or the MOSFET 404 and disabling the charge pump 114. If the mode determiner 502 selects a high-power mode, the switch driver 504 applies the second voltage (e.g., a low voltage) to the power supply switch circuit 118 of FIG. 1 or the MOSFET 404 of FIG. 4 and applies the first voltage (e.g., the high voltage) to the charge pump switch 116. In this manner, the switch driver 504 enables high-power mode by disabling the power supply switch circuit 118 or the MOSFET 404 and enabling the charge pump 114.

While an example manner of implementing the switch controller 120 of FIGS. 1 and 4 is illustrated in FIG. 5, one or more of the elements, processes and/or devices illustrated in FIG. 5 may be combined, divided, re-arranged, omitted, eliminated and/or implemented in any other way. Further, the interface 500, the mode determiner 502, the switch driver 504, and/or, more generally, the switch controller 120 of FIG. 5 may be implemented by hardware, software, firmware and/or any combination of hardware, software and/or firmware. Thus, for example, the interface 500, the mode determiner 502, the switch driver 504, and/or, more generally, the switch controller 120 of FIG. 5 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, the interface 500, the mode determiner 502, the switch driver 504, and/or, more generally, the switch controller 120 of FIG. 5 is/are hereby expressly defined to include a non-transitory computer readable storage device or storage disk such as a memory, a digital versatile disk (DVD), a compact disk (CD), a Blu-ray disk, etc. including the software and/or firmware. Further still, the switch controller 120 of FIG. 5 may include one or more elements, processes and/or devices in addition to, or instead of, those illustrated in FIG. 5, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

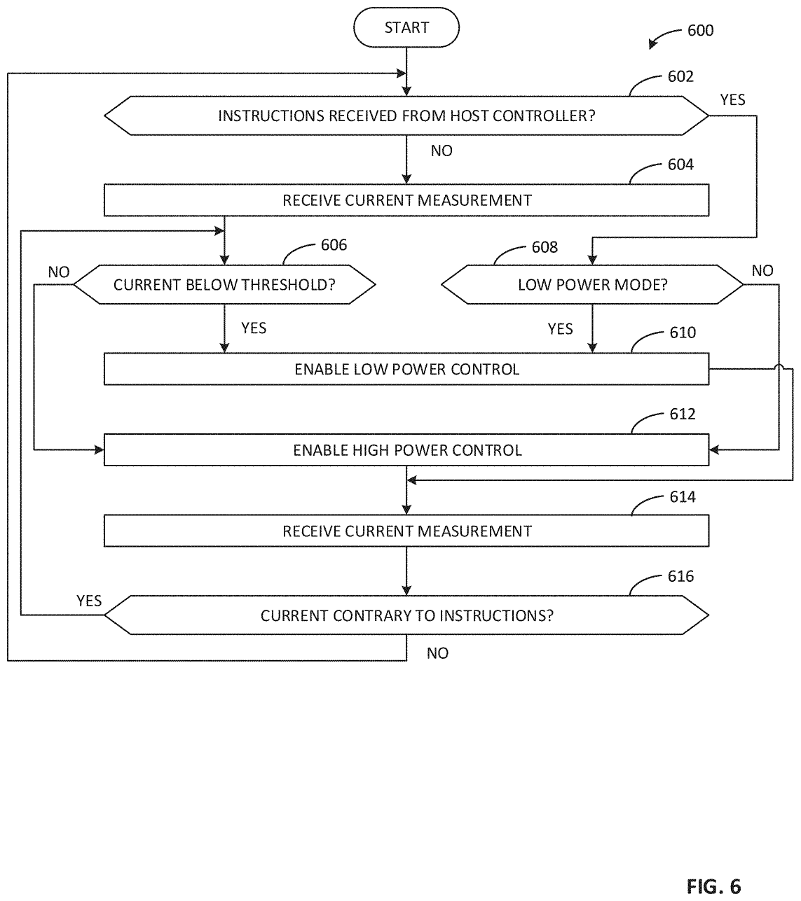

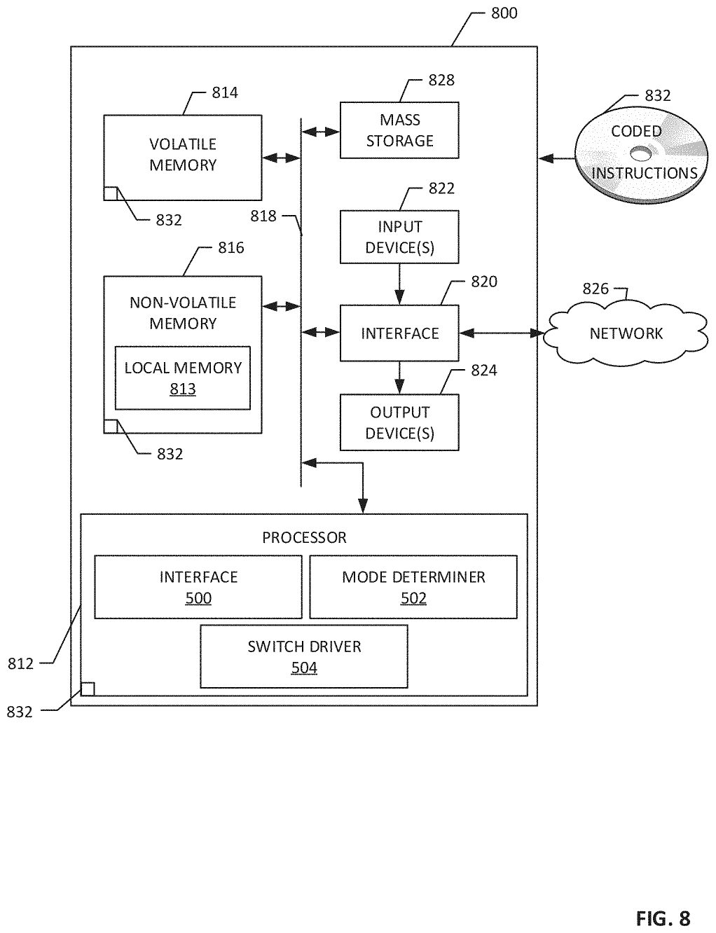

A flowchart representative of example hardware logic or machine readable instructions for implementing the switch controller 120 of FIG. 5 is shown in FIG. 6. The machine readable instructions may be a program or portion of a program for execution by a processor such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 6, many other methods of implementing the example switch controller 120 of FIG. 5 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, and (6) B with C.

FIG. 6 is an example flowchart 600 representative of example machine readable instructions that may be executed by the switch controller 120 of FIG. 1 to facilitate control for a low-power battery state. Although the example flowchart 600 of FIG. 6 is described in conjunction with the switch controller 120 in the battery packs 100, 400 of FIGS. 1 and/or 4, the flowchart 600 may be described in conjunction with any switch controller in any type of battery pack.

At block 602, the interface 500 determines if instructions have been received from the host microcontroller 126. As described above, the host microcontroller 126 may transmit instructions corresponding to a low-power mode or a high-power mode. However, if no instructions are received, the switch controller 120 may use current and/or voltage from the sensor 122 to determine which mode to use. If the interface 500 determines that instructions have been received (block 602: YES), the process continues to block 608, as further described below. If the interface 500 determines that the instructions have not been received (block 602: NO), the interface 500 receives a current measurement or a voltage measurement corresponding to a current from the sensor 122 (block 604). As described above, the sensor 122 measures the current being drawn from the power supply 102.

At block 606, the mode determiner 502 determines if the received current measurement is below a threshold (e.g., the maximum low-power threshold). If the mode determiner 502 determines that the received current measurement is below the threshold (block 606: YES), the switch driver 504 enables low-power control (block 610). As described above in conjunction with FIG. 5, the switch driver 504 enables low-power control by applying a first voltage (e.g., a high voltage) to the power supply switch circuit 118 of FIG. 1 or the MOSFET 404 of FIG. 4 and applying a second voltage (e.g., a low voltage) to the charge pump switch 116. In this manner, the switch driver 504 enables low-power mode by enabling the power supply switch circuit 118 or the MOSFET 404 and disabling the charge pump 114.

If the mode determiner 502 determines that the received current measurement is not below the threshold (block 606: NO), the switch driver 504 enables high-power control (block 612). As described above in conjunction with FIG. 5, the switch driver 504 enables high-power control by applying the second voltage (e.g., the low voltage) to the power supply switch circuit 118 of FIG. 1 or the MOSFET 404 of FIG. 4 and applying the first voltage (e.g., the high voltage) to the charge pump switch 116. In this manner, the switch driver 504 enables high-power mode by disabling the power supply switch circuit 118 or the MOSFET 404 and enabling the charge pump 114.

At block 608, the mode determiner 502 determines if the instructions from the host controller 126 correspond to a low-power mode (or a high-power mode). If the mode determiner 502 determines that the received instructions corresponds to a low-power mode (block 608: YES), the switch driver 504 enables low-power control (block 610), as described above. If the mode determiner 502 determines that the received instructions do not correspond to a low-power mode (block 608: NO) (e.g., the instructions correspond to high-power mode), the switch driver 504 enables high-power control (block 612), as described above.

At block 614, the interface 500 receives a current measurement from the sensor. 122 Alternatively, the interface 500 may receive a voltage measurement and the mode determiner 502 may determine the current by dividing the voltage by the resistance of resistor 121. At block 616, the mode determiner 502 determines if the current from the sensor 122 is contrary to the instructions from the host controller 126. For example, if the host controller 126 transmits instructions corresponding to low-power control, but the current sensed by the sensor 122 is above the threshold, the mode determiner 502 may adjust modes to protect the circuiting of the power supply pack 100, 400. If instructions have not been received, the current will not be contrary to the instructions. If the mode determiner 502 determines that the current from the sensor 122 is contrary to the instructions from the host controller 126 (block 616: YES), the process returns to block 606 to determine how to adjust control. If the mode determiner 502 determines that the current from the sensor 122 is not contrary to the instructions from the host controller 126 (block 616: NO), the process returns to block 602.

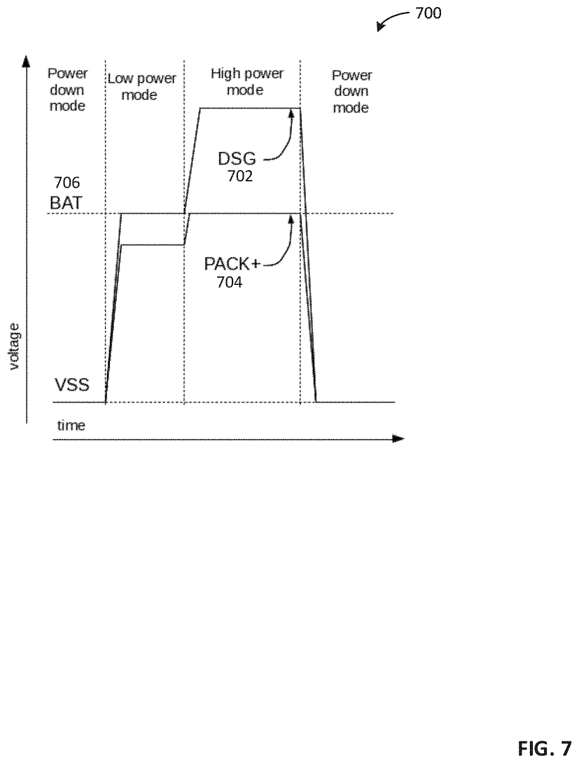

FIG. 7 illustrates an example timing diagram 700 corresponding to node voltages of FIGS. 1 and/or 4. The timing diagram 700 includes an example DSG voltage 702 corresponding to the voltage output by the protector IC 112 to the gate of the MOSFET 108 of FIGS. 1 and/or 4, an example PACK+ voltage 704 (e.g., a voltage at the DSG terminal 136), corresponding to the voltage at the PACK+ terminal 114 of the battery pack 100 of FIGS. 1 and/or 4, and an example power supply voltage 704 corresponding to the voltage output by the power supply 102 of FIGS. 1 and/or 4.

As illustrated in FIG. 7, during a power down mode the power supply voltage 704 maintains its voltage level. However, because the battery pack 100 is powered down the protector IC 112 does not output the DSG voltage 702 (e.g., the DSG voltage 702 is at ground or Vss) to the MOSFET 108. Thus, the PACK+ voltage 704 is also at ground (e.g., Vss). During low power mode, the protector IC 112 utilizes the FET switching circuit 118 to short the power supply 102 to the gate of the MOSFET 108. In this manner, the DSG voltage 702 raises to the power supply voltage 706. Additionally, during low power mode, the PACK+ voltage 704 is slightly below the power supply voltage 704 (e.g., because of the voltage drops across the body diode 107). During the high power mode, the protector IC 112 disables the FET switching circuit 118 and enabled the charge pump 114 to increase the DSG voltage 702 to provide enough voltage to enable the MOSFET 108, thereby allowing the PACK+ voltage 704 to increase to the power supply voltage 704 (e.g., because both MOSFETS 106, 108 are enabled, the power supply 102 is shorted to the PACK+ terminal 144).

FIG. 8 is a block diagram of an example processor platform 800 structured to execute the instructions of FIG. 6 to implement switch controller 120 of FIGS. 1, 4, and/or 5. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the interface 500, the mode determiner 502, and/or the switch driver 504 of FIG. 5.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface. In some examples, the interface circuit 820 implements the interface 500 of FIG. 5.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIG. 6 may be stored in the mass storage device 828, in the volatile memory 814, in the non-volatile memory 816, and/or on a removable non-transitory computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus comprising:
a charge pump coupled to a power terminal and a charge pump switch, the charge pump switch coupled to a discharging terminal;
a power supply switch circuit coupled to the power terminal and the discharging terminal, the power supply switch circuit being connected to bypass the charge pump and the charge pump switch; and
a switch controller coupled to the charge pump switch and the power supply switch circuit.

2. The apparatus of claim 1, wherein the power terminal is to couple to a positive terminal of a power supply.

3. The apparatus of claim 2, wherein the discharging terminal is to couple to a gate of a discharging field effect transistor.

4. The apparatus of claim 3, wherein, when the discharging field effect transistor is enabled, the power supply discharges toward a load.

5. The apparatus of claim 1, wherein, when the charge pump switch is enabled, the charge pump is connected to the discharging terminal and, when the charge pump switch is disabled, the charge pump is disconnected from the discharging terminal.

6. The apparatus of claim 1, wherein, when the power supply switch circuit is enabled, the power terminal is shorted to the discharging terminal and, when the power supply switch circuit is disabled, the power terminal is disconnected from the discharging terminal.

7. The apparatus of claim 1, wherein the switch controller is coupled to a data terminal, the data terminal to connect to a host microcontroller.

8. The apparatus of claim 1, wherein the switch controller is coupled to a sensor terminal, the sensor terminal to connect to a current sensor.

9. An apparatus comprising:
a power supply switch circuit to, when enabled, provide a first voltage to a discharging terminal;
a charge pump to, when enabled, provide a second voltage higher than the first voltage to the discharging terminal; and
a controller to enable the power supply switch circuit or the charge pump based on at least one of instructions from a host controller or a current being drawn from a power supply corresponding to the first voltage.

10. The apparatus of claim 9, wherein the power supply switch circuit is to, when enabled, couple a power terminal to the discharging terminal, the power terminal to couple to the power supply corresponding to the first voltage.

11. The apparatus of claim 9, wherein the controller disables the power supply switch circuit when the charge pump is enabled and disables the charge pump with the power supply switch circuit is enabled.

12. The apparatus of claim 9, wherein the controller includes:
an interface to receive at least one of the current being drawn from the power supply or instructions from the host controller; and
a driver to output one or more voltages to:
enable the charge pump and disable the power supply switch circuit when at least one of the current is above a threshold value or the instructions correspond to a high-power mode; or
disable the charge pump and enable the power supply switch circuit when at least one of the current is below the threshold value or the instructions correspond to a low-power mode.

13. The apparatus of claim 9, wherein the discharging terminal is coupled to a field effect transistor, a drain of the field effect transistor being coupled to the power supply and a source of the field effect transistor being coupled to a host device.

14. The apparatus of claim 13, wherein the controller is to enable the power supply switch circuit or the charge pump to enable the field effect transistor, the enabling of the field effect transistor to cause the power supply to power the host device.

15. The apparatus of claim 9, wherein the controller is to, when the host controller provides instructions corresponding to a low-power mode and the current being drawn by the power supply is above a threshold, disabling the power supply switch circuit and enabling the charge pump.

16. The apparatus of claim 9, wherein the controller is to enable the power supply switch circuit to bypass the charge pump.

17. A system comprising:
a power supply;
a field effect transistor including a drain connected to the power supply and a source connected to a positive terminal; and
an integrated circuit to:
when a host device is operating in a low power mode, couple the power supply to a gate of the field effect transistor; and
when the host device is operating in a high power mode, couple a charge pump to the gate of the field effect transistor, the charge pump providing a voltage higher than a power supply voltage of the power supply.

18. The system of claim 17, wherein the integrated circuit determines that the host device is operating in low power mode or high power mode based on at least one of a comparison of a current being drawn from the power supply to a threshold or instructions from the host device.

19. The system of claim 17, wherein the integrated circuit includes:
a power supply switch circuit to, when enabled, couple the power supply to the gate of the field effect transistor; and
a charge pump switch to, when enabled, couple the charge pump to the gate of the field effect transistor; and
a controller to enable the power supply switch circuit or the charge pump switch based on at least one of a current or instructions from the host device.

20. The system of claim 19, wherein the field effect transistor is a first field effect transistor, further including a second field effect transistor, including a second source connected to the power supply and a second drain connected to the drain of the first field effect transistor.

21. (canceled)

22. (canceled)
